(19) United States
(12) Patent Application Publication
(10) Pub. No.: US 2018/0072020 A1
(43) Pub. Date: Mar. 15, 2018

(54) BATCH PRINT LABEL WITH RECYCLABLE BACKER

(71) Applicant: MAXStick Products Ltd., Lancaster, PA (US)

(72) Inventors: Michael Vigunas, Lititz, PA (US); Charles Thiaville, Manlius, NY (US); William R. Krahl, Baldwinsville, NY (US)

(21) Appl. No.: 15/702,090

(22) Filed: Sep. 12, 2017

Related U.S. Application Data
(60) Provisional application No. 62/393,410, filed on Sep. 12, 2016.

(51) Int. Cl. B32B 7/12; B32B 33/00; B65C 9/18

(52) U.S. Cl. CPC B32B 7/12; B65C 2009/0087; B65C 9/1865; B32B 33/00

(57) ABSTRACT

A recyclable web of media for batch printing labels includes a recyclable label media which includes a substrate to accept printing on a first side of the substrate. An adhesive or pattern of adhesive is deposited on a second surface of the substrate opposite the first side of the substrate. A recyclable backing structure includes a print label backer material. A recyclable release layer coats one surface of the print label backer material. The recyclable backing structure is non-permanently and removably affixed to a surface of the adhesive or pattern of adhesive.

### CROSS-REFERENCE TO RELATED APPLICATIONS

This application claims priority to and the benefit of co-pending U.S. provisional patent application Ser. No. 62/393,410, BATCH PRINT LABEL WITH RECYCLABLE BACKER, filed Sep. 12, 2016, which application is incorporated herein by reference in its entirety.

### FIELD OF THE APPLICATION

The application relates to printer labels and particularly to batch print labels with a recyclable print label backer material.

### BACKGROUND

Print labels are in wide use. Transferrable print labels, for example, can be used with any type of product as it is called from inventory or produced upon ordering.

### SUMMARY

According to one aspect, a recyclable web of media for batch printing labels includes a recyclable label media which includes a substrate to accept printing on a first side of the substrate. An adhesive or pattern of adhesive is deposited on a second surface of the substrate opposite the first side of the substrate. A recyclable backing structure includes a print label backer material. A recyclable release layer coats one surface of the print label backer material. The recyclable backing structure is non-permanently and removably affixed to a surface of the adhesive or pattern of adhesive.

In one embodiment, the recyclable release layer includes a substantially silicone free material.

In another embodiment, the substantially silicone free material includes trace amounts or trace components of silicone.

In yet another embodiment, the recyclable release layer includes a starch or cellulose coating.

In yet another embodiment, the recyclable release layer includes a combination of starch and cellulose.

In yet another embodiment, the recyclable release layer comprises a modified acrylic based material.

In yet another embodiment, the recyclable release layer comprises a bio-based material.

In yet another embodiment, the recyclable release layer includes an aqueous modified maltodextrin dispersion.

In yet another embodiment, the print label backer material includes a paper.

In yet another embodiment, the substrate includes a paper or a cellulose.

In yet another embodiment, the substrate includes a thermal paper.

In yet another embodiment, the substrate includes a film.

In yet another embodiment, the film includes a plastic or a metal, or a combination thereof.

In yet another embodiment, the adhesive is present over the substrate in an adhesive pattern, the adhesive pattern defined by instances of adhesive and instances of substrate not covered by the adhesive.

In yet another embodiment, the adhesive includes a pattern of adhesive strips.

In yet another embodiment, the adhesive includes a pattern of adhesive shapes and areas or strips without adhesive to provide an adhesive free cutting section perpendicular to a long direction of the recyclable web of media for batch printing labels.

In yet another embodiment, the pattern of adhesive strips includes adhesive strips which alternate from side to side of the batch printing labels.

In yet another embodiment, the adhesive includes a pattern of or adhesive circles or adhesive ellipses.

In yet another embodiment, the adhesive includes a pattern of adhesive squares or adhesive rectangles.

In yet another embodiment, the adhesive includes a pattern of adhesive triangles or adhesive chevrons.

In yet another embodiment, the recyclable web of media for batch printing labels includes a continuous recyclable web of media for batch printing labels for use in a printer having an auto-cutting mechanism wherein the recyclable web of media for batch printing labels is caused to be printed and cut by the auto-cutting mechanism to a variable length determined by an amount of printing on the recyclable web of media for batch printing labels, the adhesive will extend in a continuous manner along a length of the continuous recyclable web of media for batch printing labels to form a repositionable label.

In yet another embodiment, the recyclable web of media for batch printing labels includes a label media wherein the adhesive forms a variably patterned adhesive layer which include areas with adhesive and areas without adhesive to vary locations of contact between the variably patterned adhesive layer and a cutting mechanism making variably located lateral cuts across width of the substrate, and wherein the variably patterned adhesive layer is substantially continuous along a longitudinal axis of the substrate such that each lateral cut of the substrate is made through areas without adhesive.

In yet another embodiment, the recyclable web of media for batch printing labels further comprises a base coat disposed between said substrate and said adhesive or pattern of adhesive.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 shows FIG. 9 of the prior art label structure of U.S. Pat. No. 8,445,104;

FIG. 2 shows an exemplary embodiment of a recyclable label structure having a recyclable peel away backer;

FIG. 3 shows an exemplary embodiment of a recyclable print label structure having a recyclable peel away backer;

FIG. 4 shows an exemplary embodiment of a web of recyclable print label structure having a recyclable peel away backer;

FIG. 5 shows another exemplary embodiment of a web of recyclable print label stock structure having a recyclable peel away backer;

FIG. 6 shows yet another exemplary embodiment of a web of recyclable print label stock structure having a recyclable peel away backer;

FIG. 7 shows yet another exemplary embodiment of a web of recyclable print label stock structure having a recyclable peel away backer; and

FIG. 8 shows yet another exemplary embodiment of a web of recyclable print label stock structure having a recyclable peel away backer.

### DETAILED DESCRIPTION

New label adhesives led to labels which can be applied without permanently marking a surface. Many such labels maintain their adhesive properties on removal and can be transferred and adhered to another surface. One problem in producing webs or rolls of transferrable labels, was that the adhesive could adhere to either or both of the dispensing rollers and the label cutting blade fouling the printer. The solution was the application of a backer to the labels to protect the printer mechanisms from the adhesive. Unfortunately, such backers once peeled from the labels before application are generally not recyclable. While the backer material itself might not be recyclable, the primary reason backers cannot be recycled is the silicone coating on the backer which allowed the backer to peel free from the adhesive on the back of the label.

In U.S. Pat. No. 8,445,104, we described a solution where a new type of recyclable layer was added to the structure of the label above the thermo-reactive image coating of a thermal release paper. According to the '104 patent, a continuous liner-free repositionable label roll for use in a thermal point-of-sale printer has an auto-cutting mechanism. A web of thermal paper has a top surface and a bottom surface wound into a continuous roll without preset tear areas thereon. A base coat is provided on the bottom surface. At least one adhesive strip is provided on the bottom surface. The adhesive strip extends in a substantially uninterrupted manner along a running axis of the web wherein the base coat secures the adhesive of the at least one adhesive strip to the bottom surface to prevent fouling of the auto-cutting mechanism of the point of sale printer. The adhesive of the at least one adhesive strip includes acrylate copolymer formed into microparticles, microspheres or combinations thereof. A silicone-free release coat is provided on the top surface. The release coat extends along the running axis of the web and behind the at least one adhesive strip so that when the web of thermal paper is caused to be thermally printed and cut by the auto-cutting mechanism to a variable length determined by the amount of printing on the web. The adhesive extends in a continuous manner along the length of the thermally printed paper to form a repositionable label.

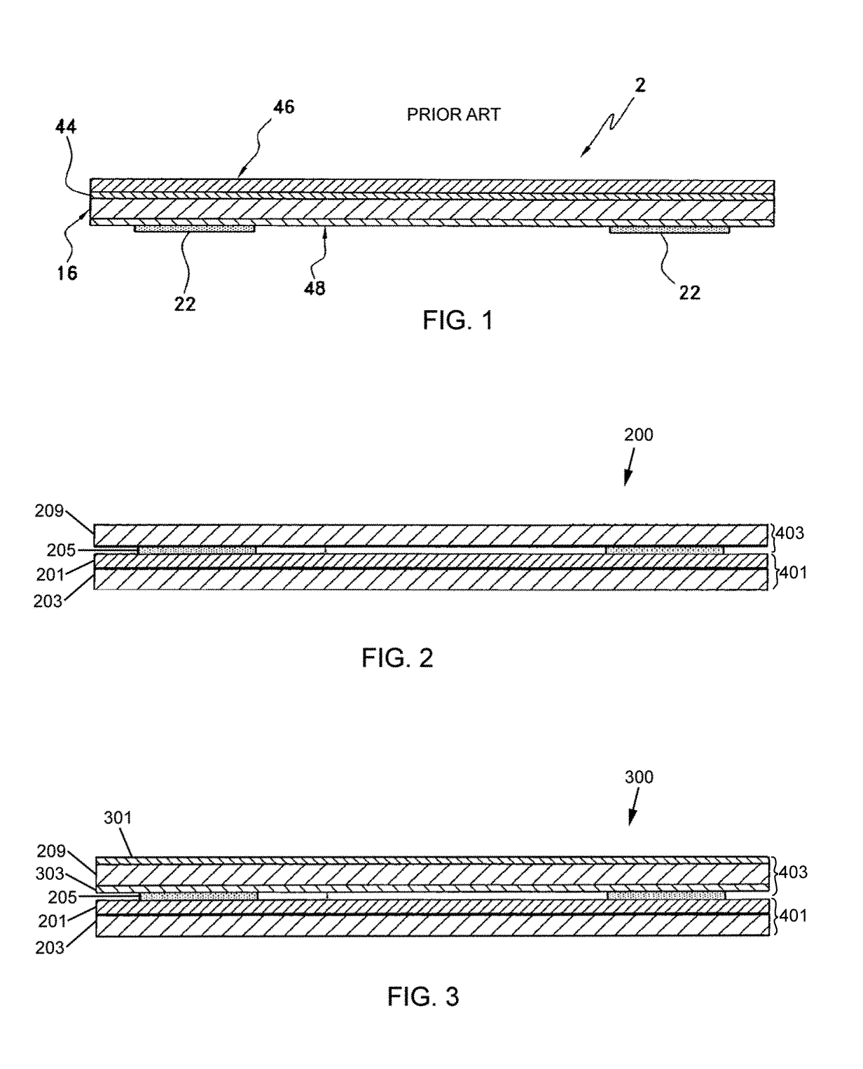

Turning to FIG. 1 (FIG. 9 the '104 patent), a label 2 formed from thermosensitive recording material according to the present invention is shown to comprise a substrate 44 in the form of a sheet material having first and second surfaces. Generally speaking, the substrate 44 may be any high quality paper or other cellulosic or synthetic sheet material readily adapted to receive a thermosensitive or thermoreactive coating. Such papers are well known in the art.

A first or upper surface of substrate 16 is provided with a thermosensitive or thermoreactive coating 44 comprising initially colorless color formers and color developers. Suitable thermally imagable coatings include, for example, the thermosensitive and thermoreactive coatings described in U.S. Pat. No. 6,258,746 the relevant portions of which are incorporated herein by reference for all purposes. It is within the scope of the present invention to provide a stock thermal paper for use as substrate 16. Stock thermal papers are pre-coated with a thermosensitive or thermoreactive coating and may further include various other ingredients designed to protect the thermal imaging properties of the thermosensitive coating prior to and following thermal printing. Stock thermal papers are commercially available from a variety of manufacturers including, for example, Appleton Papers, Kanzaki Specialty Papers and Ricoh. Stock thermal papers which are available from other sources are within the scope of the present invention so long as they are adapted to receive the additional coatings and layers as further described below.

A second or underside surface of the substrate 16 is provided with a base coat preparation 48 that is coated onto the substrate 16 and then cured by heat or some other curing means. The base coat preparation 48 functions as a barrier to prevent migration of a subsequently applied adhesive into the substrate 16. The base coat preparation will also prevent the adhesive from contacting the substrate 16 and in particular, the thermal imaging coating 44. This ensures there is no premature activation or damage to the pigments within the thermal imaging coating 44. The base coat preparation 48 additionally functions to secure the adhesive to the label 2 so that it cannot be dislodged from the surface of the label during unrolling of the web. Suitable base coat preparations within the scope of the present invention are disclosed in U.S. Pat. No. 5,157,012, U.S. Pat. No. 5,071,821 and U.S. Pat. No. 4,870,047, which are incorporated herein by reference for all purposes.

A top surface coat 46 is provided over thermoreactive layer 44. The top surface coat 46 can be a starch or cellulose coating or a combination of starch and cellulose. The top surface coat functions as a type of release liner when the continuous web is in a roll form. That is, it enables the roll to be easily unwound despite the presence of an adhesive layer while at the same time it will not damage or otherwise deteriorate the adhesion characteristics of the pressure sensitive adhesive coating as the roll is unwound. In other words, the top surface coat 46 counteracts the pressure sensitive nature of the adhesive. The top surface coat is not damaged by the adhesive or otherwise separated from the recording material as the roll is unwound. A suitable composition for use as a top surface coat of the present invention is an aqueous modified maltodextrin dispersion marketed under the name SECOAT R 51 and manufactured by Omnova Solutions, Inc. of Chester, S.C. Other compositions for the top surface coat are within the scope of the present invention so long as it functions as a release liner in the manner described above and enables the roll to be easily unwound despite the presence of an adhesive layer and does not deteriorate the adhesion characteristics of the pressure sensitive adhesive coating as the roll is unwound.

An adhesive coating 22 is applied by printing or other means onto the base coat 48 and is best shown in FIG. 3 the '104 patent (not shown) to comprise two parallel, continuous and uninterrupted lengths that extend along the longitudinal axis of the web of labels. As is apparent, the adhesive is not limited to the locations shown in FIG. 3 the '104 patent (not shown) but may extend substantially over the entire surface of the underside of the substrate 16 and in a continuous and uninterrupted manner as best shown in FIG. 5 the '104 patent (not shown).

The adhesive of the '104 patent as well as this application can include clusters of tacky, elastomeric, solvent-insoluble, polymeric microparticles or microspheres or a combination of microparticles and microspheres that have been prepared by aqueous emulsion polymerization. Polymerization is initiated by reacting an aqueous suspension comprising monomers having at least one substantially water insoluble ester of alkyl acrylate or methacrylate, a stabilizer and an emulsifier together with a water-soluble redox polymerization initiator to produce clusters of elastomeric microparticles. During the polymerization, the monomers will form microparticles and/or microspheres that gradually coagulate to form clusters. Preferably, the polymerized microparticles form clusters having an average size about 300 microns, preferable between about 300 and 2,000 microns. The microparticles are spherical and have diameters in the range of from about 5 to about 200 microns.

A water-soluble redox system initiator comprises a pair of oxidizing and reducing agents is employed during polymerization. The oxidizing agent is preferably a persulfate such as ammonium persulfate, although a sodium persulfate or others may be used. The concentration of the persulfate is from about 0.25% to about 1.0% by weight of the monomers and preferably 0.75% by weight of the monomers. The reducing agent is ethylenedinitrilotetraacetic acid sodium ion (+3) salt (EDTA-Fe(3+)) that must be reduced by a second reducing agent, such as sodium formaldehyde sulfoxylate. The concentration of EDTA-Fe(3+) and sodium formaldehyde sulfoxylate is about 0.05 percent and about 0.5 percent by weight of the monomers, respectively.

In one embodiment of '104 patent, the adhesive coating 22 of the present invention is prepared in the presence of a protective colloid casein. The microspheres or microparticles forming the adhesive are prepared via aqueous suspension polymerization of: (1) from 70 to 99.9 percent by weight of one or more monomers selected from the group consisting of alkyl acrylate esters and alkyl(meth)acrylate esters, (2) from 0.1 to 10 percent by weight of one or more alpha-mono-olefin carboxylic acids (crotonic acid) and (3) from 0 to about 29.9 percent by weight of one or more vinyl monomers other than those identified above as (1) and (2).

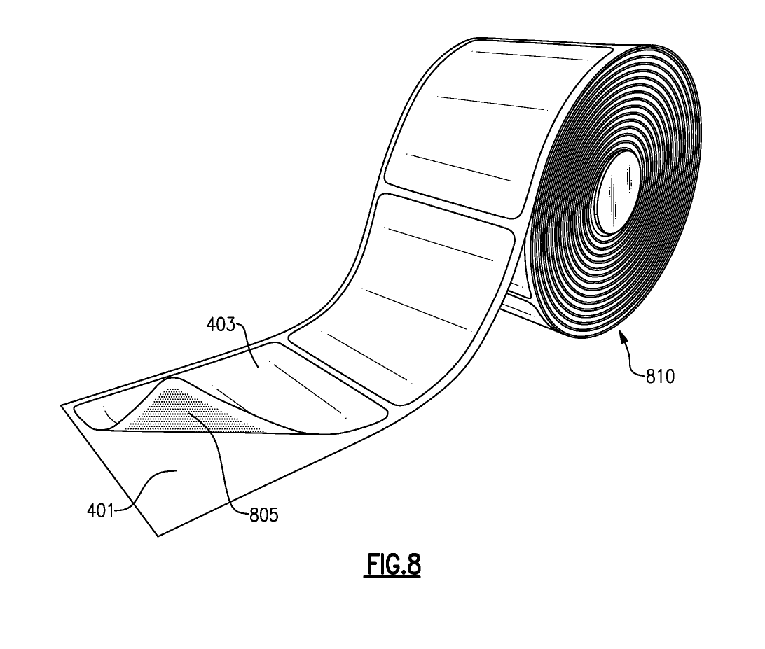

The above described acrylate copolymer adhesive displays an aggressive initial tack but with low adhesion peel properties and eliminates the prior art need for a release liner or other silicone layer to protect the adhesive. The acrylate copolymer adhesive of the present invention permits a printed label 2 of the present invention to be repeatedly removed and re-adhered i.e. repositioned onto any suitable surface, for example a customer bag B as shown in FIG. 7 of the '104 patent (not shown) or to secure the wrapping 42 around a foodstuff as shown in FIG. 8 the '104 patent (not shown) and when the label is in the form of a receipt, it also functions to identify the contents of the wrapping or bag. The acrylate copolymer adhesive of the present invention has does not result in adhesive buildup on the moving parts of the thermal printer which, as noted earlier, can adversely affect the performance of the printer and the cutter bar. As a result, the adhesive of the present invention need not be applied to the web in limited areas in an effort to reduce adhesive buildup within the printer. The label according to the present invention therefore provides superior adhesion due to the relatively large surface area of the adhesive and the continuous and uninterrupted extent of the adhesive along the entire length of the printed label.

In U.S. Pat. No. 9,208,699, we described a label media which includes a substrate having a first and a second side opposite the first side and a longitudinal axis, a thermally sensitive coating on the first side of the substrate, and an adhesive layer on the second side of the substrate; a top surface release coat coated over the thermally sensitive coating. The adhesive layer is variably patterned to include areas with adhesive and areas without adhesive to vary locations of contact between the adhesive layer and a cutting mechanism making variably located lateral cuts across width of the substrate. The patterned adhesive layer is substantially continuous along the longitudinal axis of the substrate such that each lateral cut of the substrate intersects with the adhesive layer.

Thermally printed labels according to the '104 patent are recyclable. Such labels are commonly printed, for example, by point of sale (POS) terminals in fast food restaurants to associated a receipt and/or food items with a particular customer. Labels made according the '104 patent can be properly recycled along with the food packaging wrap, paper, bag, box, etc. Also, adhesive strips were printed on sides of the paper to facilitate non-stick handling (e.g. food worker gloves) as well as to minimize printer fouling by adhesive. The '104 and '699 patents are incorporated herein by reference in their entirety for all purposes.

There is now a demand for batch printing such transferable labels. In batch label printing, some desired number of labels can be printed in one or more print operations and then later applied to a surface as desired.

While our recyclable labels can be used in any suitable application, there are problems in batch printing labels without a backing layer to protect the label and more particularly its adhesive layer. For example, batch printed labels from a web or label according to the '104 and '699 patents were intended to be applied shortly after printing. If some large number of batch printed labels were so printed, they might begin to interfere with each other, such as by sticking together, or rolling closed and self-adhering to themselves.

Another problem with prior art thermally printed labels is that the labels generally need a thermally reactive image coating layer. Such thermally sensitive labels are more difficult to work with both in manufacturing and in storage. In manufacturing care must be taken in adding layers so as not to inadvertently activate or change the state of the thermally sensitive ink. For example, there were significant limitation to how the new recyclable was applied above the thermally reactive image coating layer, so as not to inadvertently print areas or otherwise damage the thermal ink layer. Some thermal limitations prevented some improvements in the new top surface coat release layer.

We realized surprising, that a solution to many of the aforementioned problems is to return to a label with a backing structure, where now the backing structure includes our new recyclable release layer. However, instead of adding the recyclable release layer over a thermoreactive image coating as we did in the '104 and '699 patents, now we apply the recyclable release layer over a removable (e.g. peel-able) print label backer material. There is no longer need for the recyclable release layer on to the top surface of the label. The recyclable release layer has moved from the upper surface of the label to the backer material. There can be many embodiments of the label which is not limited to thermal printer paper. Also, the substrate or sheet material can now be made from any suitable sheet material and made suitable for a range of printer processes other than thermal printing, including, for example, ink jet printing, laser printing, etc. Suitable sheet materials include, for example, paper, cellulose, or films.

Most label stock that uses a release layer, such as a backing sheet or strip that is pulled away from an adhesive label just prior to use, is based on a silicone release layer. The silicone of the release layer is cured in place by light, temperature, and/or pressure to bind the silicone release layer to a backing substrate. The resulting removable backing layer is non-recyclable because of the significant amount of silicone material present on the backer. Indeed, to try to overcome the problem of non-recyclable backer waste, a necessary first step in the process, is to de-siliconize the backer strips or sheets.

Definitions

Recyclable release layer—A recyclable release layer is substantially silicone free. As used hereinbelow, small amounts or trace amounts or trace components of silicone is defined to mean less than about 5% by weight of silicone. A water based pre-reactived silicone derivative, such as used in some embodiments of the Application may still include very small, or in some embodiments, even trace amounts or trace components of silicone. Any small amounts, or trace amounts or trace components of silicone which remain in the release layer materials were already or pre-activated cross linked during the manufacture of the release material which is substantially silicone free. Such small amounts or trace amounts or trace components of silicone are known to be allowed into regular waste re-cycling streams, as compared to traditional removable backers with silicone release layers which include substantial amounts of silicone material and which traditional backers are not recyclable.

FIG. 2 shows an exemplary embodiment of a recyclable label stock 200 with removable adhesive backed labels 403 on a recyclable backing structure 401. The label of FIG. 2 is typically printed on the exposed side of the substrate 209. An adhesive 205 can be applied directly to a second surface of the substrate 209 opposite the surface to be printed. The adhesive can cover the entire surface, or can be present in any suitable pattern of adhesive deposited over the back surface of the substrate. However, a difference from the earlier embodiments of the '104 and '699 patents is that now we realize that we can create a recyclable peel away backer by providing a peel away strip or section as a batch print label carrier media or batch print label backer material, hereinafter referred to as batch print label backer material (e.g. batch print label backer material 203). In place of the non-recyclable silicone coating of the prior art, we coat the surface of the batch print label backer material 203 with a recyclable release layer. The release coating material can be composed of starch or cellulose, modified acrylic based materials, bio-based materials, or any combination thereof. The recyclable release layer structure, recyclable peel away backer 401 is adjacent to and protecting the adhesive 205 with a substantially silicone free top surface coat 201 (analogous to 46 of the '104 patent) and can counteract the pressure sensitive nature of the adhesive.

FIG. 3 shows another exemplary embodiment of a recyclable label stock 300 with removable adhesive labels 403 on a recyclable backing structure 401. The exemplary structure of FIG. 3 shows how while any suitable substrate material can be used for the substrate of FIG. 2, it is contemplated that there could also be embodiments where the substrate 209 is coated with a thermally activated imaging material 301 to provide recyclable thermally printed batch labels using any suitable conventional thermal printer. In some embodiments of thermally printed labels, it can be desirable to further add a base coat 303 between the back surface of the substrate and the adhesive layer, or patterns of adhesive. When optionally used, a base coat 303 can prevent the adhesive 205 from contacting the substrate 209 and in particular, the thermal imaging coating 301.

Release materials as coatings for removable backers.

Suitable release coatings include a dispersion or emulsion of a film forming polymeric material and at least one release additive. The film forming polymeric material can be formed from one or more ethylenically unsaturated monomers by typical polymerization techniques, such as solution or emulsion polymerization. Suitable monomers include (meth)acrylic acid, alkyl esters of (meth)acrylic acid such as methyl methacrylate, ethylmethacrylate, butyl methacrylate, isobutymethacrylate, and hexymethacrylate. Other suitable monomers include hydroxyalkyl esters of acrylates such as hydroxyethylmethacrylate, styrene, butadiene, ethylene, acrylonitrile, acrylamide, vinyl chloride, vinyl esters of alcohols such as vinyl acetate, and suitable combinations thereof.

Suitable film forming polymers (polymeric materials) include emulsions of latex polymers having acrylic, vinyl ester/acrylic, and vinyl acetate/ethylene polymers. Functionalized monomers, such as, acrylic acid and methacrylic acid, acrylamide, N-methylolacrylamide and the like can be incorporated, for example, into the polymer at a level of about 1-20% by weight of polymeric material. The film forming polymer is used as about 50 to 99% of the dry weight of the film. The film forming polymer can be crosslinkable or curable during or after drying.

Release additives can include coatings such as alkyl aryl polyalkyleneoxides, salts of long chain alkyl sulfates, and dialkylesters of sulfosuccinic acid. Other suitable release promoting additives include hydrocarbon wax dispersions, silicone copolymers or block copolymers with alkyleneoxides, fluorocarbon neutral, anionic or cationic compounds or polymers, quaternary alkyl ammonium salts, alkanoic esters of polyols, and monoalkanoic ester of polyols. In some embodiments, two or more release agents may be used in any suitable combination to provide a better-behaved release of the backer material. The total amount of release agent or agents can be about 0.5% to 50% of the dry weight of the film. The total amount of release agent can be added at about 1% to 30% of the dry film weight.

The release coating can also include other additives such as surfactants, antifoaming agents, crosslinkers, rheology modifying agents, pigments, catalysts, and antimicrobial additives.

The media for the label substrates can be any suitable label substrate media. Suitable substrate materials include, for example, any suitable paper, ink jet substrates, thermal transfer substrates, polyvinyl, any suitable films including, for example, paper films, cellulose films, plastic films, metal films, etc.

Similarly, the batch print label backer material can also be made any suitable backer media. Suitable backer materials include, for example, any suitable paper, polyvinyl, or any suitable films including, for example, paper, films, cellulose films, plastic films, metal films, etc., or any combination thereof. The print label backer material can be made economically and efficiently from paper or paper strips of any suitable thickness.

Adhesive patterns: Any suitable pattern of adhesive can be used ranging from a continuous coverage of the surface, a partial coverage of the surface, to deposits or patterns of adhesive on the surface surrounded and/or separated by adhesive free areas. Suitable patterns of adhesive, were described for example in the '104 and '699 patents described hereinabove. Other exemplary adhesive patterns can be seen in U.S. Pat. No. 7,588,811, U.S. Pat. No. 7,820,264, U.S. Pat. No. 8,537,184, and U.S. Pat. No. 8,711,190 which are incorporated herein by reference for all purposes.

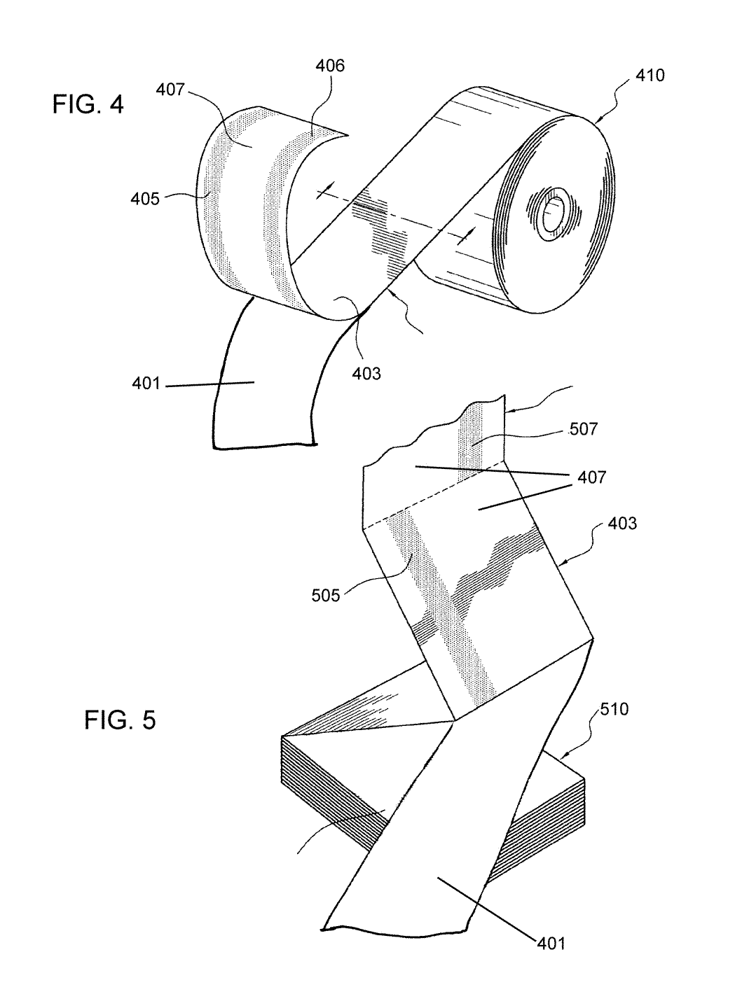

In the exemplary embodiments which follow, the label stock (410, 510, 610, 810) includes adhesive backed labels 403 with various exemplary adhesive patterns (405, 505, 605, 705, 805), which separate from a recyclable peel away backer 401. The substantially silicone free top surface coat 201 of the recyclable peel away backers 401 may or may not be predominant and/or visible (e.g. the substantially silicone free top surface coat 201 can be optically transparent) on the surface of the recyclable peel away backer 401 and is not shown in FIG. 4 to FIG. 8.

FIG. 4 shows an exemplary embodiment of a web 410 (a roll) of recyclable print label structure having a recyclable label media 403 and a recyclable peel away backer 401. Adhesive areas are 405 are shown separated by non-adhesive areas 407.

FIG. 5 shows another exemplary embodiment of a web 510 of (folded) recyclable print label structure having a recyclable label media 403 and a recyclable peel away backer. Adhesive areas are 505, 507 are shown separated by non-adhesive areas 407.

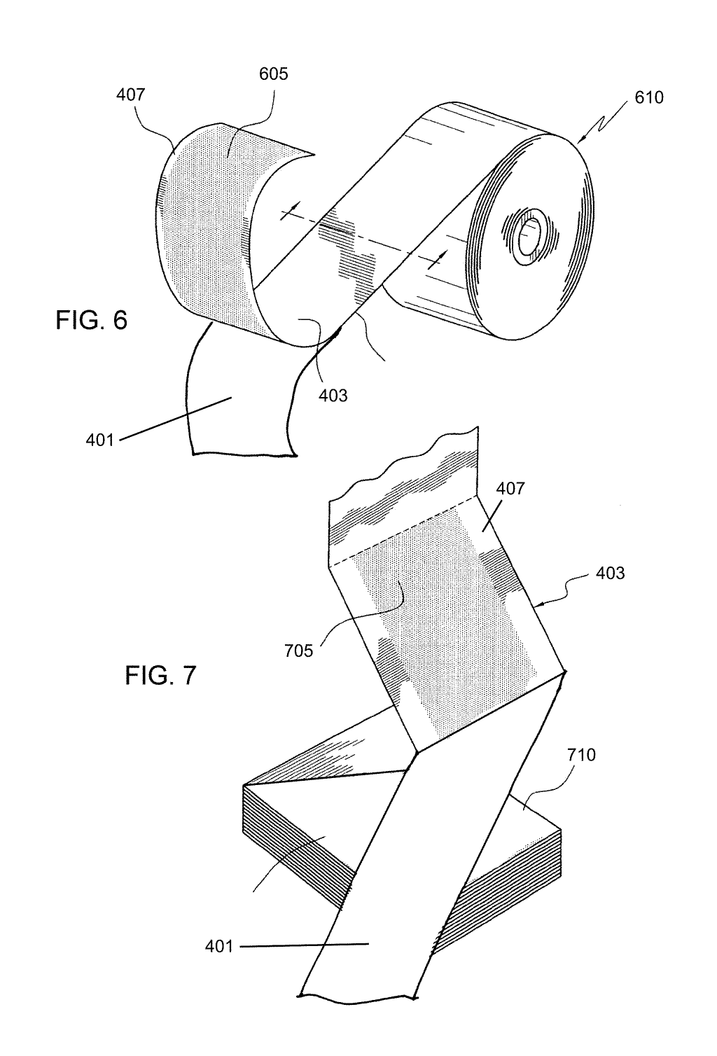

FIG. 6 shows yet another exemplary embodiment of a web 610 (a roll) of recyclable print label structure having a recyclable label media 403 and a recyclable peel away backer 401. Adhesive area 605 is shown separated with non-adhesive areas 407.

FIG. 7 shows yet another exemplary embodiment of a web 710 of (folded) recyclable print label structure having a recyclable label media 403 and a recyclable peel away backer 401. Adhesive area 705 is shown separated by non-adhesive areas 407.

FIG. 8 shows yet another exemplary embodiment of a web 810 of (a roll) recyclable print label structure having a recyclable label media 403 and a recyclable peel away backer 401. Adhesive area 805 is shown separated by non-adhesive areas 407.

In some embodiments, labels with recyclable backers can be made as one continuous label (without pre-die cut labels). Such labels can be particularly suitable for use in batch printing labels where a printer has a cutter and the operator wants to create variable length labels with the carrier to be peeled at a later time when needed.

In some embodiments, labels with recyclable backers can be made to work with a printer which has a gap sensor to read the position of the label in the printer. Alternatively, it is contemplated that labels can include a black top-of-form mark in place of, or in addition to a gap sensor for printers that reads a black mark vs. a gap (e.g. between each die-cut label).

While embodiments described hereinabove typically use a low-tack adhesive (low adhesion), the recyclable backers described hereinabove can also be used with any suitable non-repositionable or permanent labels (e.g. labels with permanent adhesives).

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A recyclable web of media for batch printing labels comprising:
a recyclable label media comprising:
a substrate to accept printing on a first side of said substrate;
an adhesive or pattern of adhesive deposited on a second surface of said substrate opposite said first side of said substrate;
a recyclable backing structure comprising:
a print label backer material;
a recyclable release layer coats one surface of said print label backer material; and
wherein said recyclable backing structure is non-permanently and removably affixed to a surface of said adhesive or pattern of adhesive.

2. The recyclable web of media for batch printing labels of claim 1, wherein said recyclable release layer comprises a substantially silicone free material.

3. The recyclable web of media for batch printing labels of claim 1, wherein said substantially silicone free material comprises trace amounts or trace components of silicone.

4. The recyclable web of media for batch printing labels of claim 1, wherein said recyclable release layer comprises a starch or cellulose coating.

5. The recyclable web of media for batch printing labels of claim 1, wherein said recyclable release layer comprises a combination of starch and cellulose.

6. The recyclable web of media for batch printing labels of claim 1, wherein said recyclable release layer comprises a modified acrylic based material.

7. The recyclable web of media for batch printing labels of claim 1, wherein said recyclable release layer comprises a bio-based material.

8. The recyclable web of media for batch printing labels of claim 1, wherein said recyclable release layer comprises an aqueous modified maltodextrin dispersion.

9. The recyclable web of media for batch printing labels of claim 1, wherein said print label backer material comprises a paper.

10. The recyclable web of media for batch printing labels of claim 1, wherein said substrate comprises a paper or a cellulose.

11. The recyclable web of media for batch printing labels of claim 1, wherein said substrate comprises a thermal paper.

12. The recyclable web of media for batch printing labels of claim 1, wherein said substrate comprises a film.

13. The recyclable web of media for batch printing labels of claim 9, wherein said film comprises a plastic or a metal, or a combination thereof.

14. The recyclable web of media for batch printing labels of claim 1, wherein said adhesive is present over said substrate in an adhesive pattern, said adhesive pattern defined by instances of adhesive and instances of substrate not covered by said adhesive.

15. The recyclable web of media for batch printing labels of claim 1, wherein said adhesive comprises a pattern of adhesive strips.

16. The recyclable web of media for batch printing labels of claim 10, wherein said adhesive comprises a pattern of adhesive shapes and areas or strips without adhesive to provide an adhesive free cutting section perpendicular to a long direction of said recyclable web of media for batch printing labels.

17. The recyclable web of media for batch printing labels of claim 12, wherein said pattern of adhesive strips comprises adhesive strips which alternate from side to side of said batch printing labels.

18. The recyclable web of media for batch printing labels of claim 1, wherein said adhesive comprises a pattern of or adhesive circles or adhesive ellipses.

19. The recyclable web of media for batch printing labels of claim 1, wherein said adhesive comprises a pattern of adhesive squares or adhesive rectangles.

20. The recyclable web of media for batch printing labels of claim 1, wherein said adhesive comprises a pattern of adhesive triangles or adhesive chevrons.

21. The recyclable web of media for batch printing labels of claim 1, comprising a continuous recyclable web of media for batch printing labels for use in a printer having an auto-cutting mechanism wherein said recyclable web of media for batch printing labels is caused to be printed and cut by the auto-cutting mechanism to a variable length determined by an amount of printing on said recyclable web of media for batch printing labels, said adhesive will extend in a continuous manner along a length of said continuous recyclable web of media for batch printing labels to form a repositionable label.

22. The recyclable web of media for batch printing labels of claim 1, comprising a label media wherein said adhesive forms a variably patterned adhesive layer which include areas with adhesive and areas without adhesive to vary locations of contact between said variably patterned adhesive layer and a cutting mechanism making variably located lateral cuts across width of the substrate, and wherein said variably patterned adhesive layer is substantially continuous along a longitudinal axis of said substrate such that each lateral cut of said substrate is made through areas without adhesive.

23. The recyclable web of media for batch printing labels of claim 1, further comprising a base coat disposed between said substrate and said adhesive or pattern of adhesive.
